(19) United States
(12) Patent Application Publication
(10) Pub. No.: US 2009/0302763 A1
(43) Pub. Date: Dec. 10, 2009

(54) PLASMA DISPLAY PANEL AND METHOD FOR MANUFACTURING THE SAME

(76) Inventors: Taiki Makino, Miyazaki (JP); Masahiro Sawa, Miyazaki (JP); Koji Ohira, Miyazaki (JP); Akihiro Fujimoto, Miyazaki (JP)

Correspondence Address: STAAS & HALSEY LLP, SUITE 700, 1201 NEW YORK AVENUE, N.W., WASHINGTON, DC, 20005, US

(21) Appl. No.: 12/296,376

(22) PCT Filed: May 31, 2006
(86) PCT No.: PCT/JP2006/310915

§ 371 Date: Feb. 2, 2009

(51) Int. Cl. H01J 17/49; H01J 11/02

(52) U.S. Cl. 313/582; 445/25

(57) ABSTRACT

In a plasma display panel wherein lattice-like ribs are formed, an impurity gas inside the panel is easily exhausted. The panel has a paired substrates facing each other. The peripheral portions of the panel are bonded to each other to be sealed. The panel is manufactured by allowing an impurity gas located between the substrates to be exhausted upon carrying out the sealing/bonding process. The panel includes a cell-defining rib and a dummy rib. The cell-defining rib has longitudinal ribs and lateral ribs, which is formed in a display area between the paired substrates. The dummy rib has the same shape as that of the cell-defining rib, which is formed in a non-display area which covers from an outer edge of the display area over to the periphery of the substrates, a ventilation passage being formed in the non-display area in which the dummy rib is formed.

### TECHNICAL FIELD

This invention relates to a plasma display panel (hereinafter, referred to as a “PDP”) and a method for manufacturing the same, and specifically relates to a PDP in which a frontside substrate and a backside substrate are aligned face to face with each other and peripheral portions are bonded to each other to be sealed with a sealing/bonding material, and a method for manufacturing the same.

### BACKGROUND ART

A three-electrode surface-discharge-type PDP of an AC-drive type has been known as a conventional PDP. This PDP is manufactured through processes in which the frontside substrate on which desired constituent elements, such as electrodes, a dielectric layer, a phosphor layer and ribs (barrier ribs), are formed and the backside substrate are aligned face to face with each other and the peripheral portions are bonded to each other to be sealed. This process for bonding the peripheral portions to each other to be sealed is referred to as a sealing process, a sealing/bonding process, a sealing/bonding/exhausting process and the like, and in the present specification, it is referred to as the sealing/bonding process.

In this sealing/bonding process, normally, a glass sealing/bonding material is applied to the peripheral portion of the backside substrate, and the frontside substrate is superposed on the backside substrate, with the peripheral portions of two substrates being sandwiched by clips to be temporarily secured, and the two substrates in this state are subjected to a heating process so that the two substrates are air-tightly bonded to each other. In this heating process, while the glass sealing/bonding material is heated to be fused, a negative pressure is applied to an inside of the PDP so that an impurity gas is exhausted from the inside of the PDP, and a discharge space inside the PDP is successively filled with a discharge gas.

The temporarily securing process by the clips is carried out by sandwiching the peripheral portions of the substrates with the clips at a plurality of positions (for example, four positions). For this reason, dummy ribs are formed up to a clip-sandwiching area on the periphery of the substrates so that the frontside substrate and the backside substrate are bonded to each other to be sealed, with a predetermined gap.

On the other hand, examples of a rib structure of the PDP include such as a linear structure (stripe rib structure) in which a plurality of ribs are provided in a longitudinal direction (column direction of display) so that the discharge space is divided only in a lateral direction (row direction of display) and a lattice-like structure (a box rib structure and a waffle rib structure) in which the discharge space is divided for each cell by providing ribs in the lateral direction and the longitudinal direction. In recent years, there have been strong demands for PDPs having the box rib structure so as to achieve high precision in pixels.

### DISCLOSURE OF THE INVENTION

### Problems to Be Solved by the Invention

However, since the PDP of the box rib structure is a closed-type rib structure, a ventilation conductance inside the panel is small, in comparison with a PDP of the stripe rib structure, resulting in a problem in which an exhausting process of the impurity gas becomes difficult. When a removal of the impurity gas is insufficient, panel performances deteriorate. More specifically, a reduction in luminance and voltage fluctuations occur due to degradation of phosphors, and panel display irregularities tend to occur.

Therefore, various structures have been proposed so as to improve a ventilation passage inside the panel. For example, a structure in which a groove is provided in a non-display area (see Patent Document 1) has been known as an attempt to enlarge the ventilation passage in the non-display area. Moreover, another structure has been known in which an attempt is made to improve an exhaust efficiency by providing more ventilation passages on a longer side of the panel than those on a shorter side thereof (see Patent Document 2).
Patent Document 1: JP-A No. 11-238466
Patent Document 2: JP-A No. 2003-217457

In view of the above state of the art, the present invention has been devised, and its object is to improve the exhaust process inside the panel in the PDP of the closed-type rib structure by forming the ventilation passage in the non-display area.

### Means to Solve the Problems

The present invention provides a plasma display panel, which has a paired substrates facing each other, the peripheral portions of which are bonded to each other to be sealed, and is manufactured by allowing an impurity gas located between the substrates to be exhausted upon carrying out the sealing/bonding process, the plasma display panel comprising: a cell-defining rib having longitudinal ribs and lateral ribs, which is formed in a display area between the paired substrates; and a dummy rib having the same shape as that of the cell-defining rib, which is formed in a non-display area which covers from an outer edge of the display area over to the periphery of the substrates, a ventilation passage being formed in the non-display area in which the dummy rib is formed.

### Effects of the Invention

In accordance with the present invention, the ventilation passage is formed in the non-display area in which the dummy rib is formed; therefore, when the paired substrates are aligned face to face with each other and the peripheral portions are bonded and sealed with each other in a PDP with closed-type ribs formed between the substrates, an exhausting operation of the impurity gas existing between the substrates can be desirably carried out so that it is possible to provide a high-quality PDP with high reliability.

### BRIEF DESCRIPTION OF THE DRAWINGS

FIGS. 1(a) and 1(b) are explanatory drawings which show a structure of a PDP in accordance with the present invention.

FIGS. 2(a) and 2(b) are partially exploded perspective views which show the PDP of the present invention in detail.

FIG. 3 is an explanatory drawing which shows a structure of embodiment 1 of the present invention.

FIG. 4 shows a comparative example of a PDP in which no ventilation passage is formed.

FIG. 5 is an explanatory drawing which shows a structure of embodiment 2 of the present invention.

FIG. 6 is an explanatory drawing which shows a structure of embodiment 3 of the present invention.

FIG. 7 is an explanatory drawing which shows a structure of embodiment 4 of the present invention.

FIG. 8 is a plan view which shows a box rib placed on a corner of a display area in the PDP of the present invention.

FIG. 9 is a plan view which shows a box rib placed on a corner of a display area in the PDP of the present invention.

### REFERENCE NUMERALS

10 PDP
11 Frontside substrate
12 Transparent electrode
13 Bus electrode
17, 24 Dielectric layer
18 Protective film
21 Backside substrate
28R, 28G, 28B Phosphor layer
29 Box rib
29a Corner portion of box rib
29b Outer edge box rib
30 Discharge space
31 Display area
32 Non-display area
33 Dummy rib
34 Clip sandwiching area
41 Glass sealing/bonding material
42 Ventilation hole
43 Ventilation passage
A Address electrode
L Display line
X,Y Display electrode

### BEST MODE FOR CARRYING OUT THE INVENTION

In the present invention, examples of the paired substrates include a substrate made of glass, quartz or ceramics and a substrate prepared by forming desired constituent elements, such as an electrode, an insulating film, a dielectric layer and a protective film, on such substrate.

The electrodes may be formed by using various materials and methods conventionally known in the art. Examples of materials used for these electrodes include transparent conductive materials, such as ITO and SnO₂, and metal conductive materials, such as Ag, Au, Al, Cu and Cr. Various methods conventionally known in the art can be used for forming the electrodes. For example, a thick-film-forming technique such as a printing may be used for forming the electrodes, or a thin-film-forming technique, such as a physical deposition method and a chemical deposition method, may be used for forming them. Examples of the thick-film-forming technique include a screen printing method and the like. In the thin-film-forming technique, examples of the physical deposition method include such as a vapor deposition method and a sputtering method. Examples of the chemical deposition method include such as a thermal CVD method, a photo CVD method, or a plasma CVD method.

In the present invention, the cell-defining rib may be formed by the longitudinal rib and the lateral rib. The longitudinal rib and the lateral rib are not necessarily required to be made orthogonal to each other, and may be prepared so as to intersect with each other with any angle. Heights of the longitudinal rib and the lateral rib are not necessarily required to be identical, and may be made different from each other.

The ventilation passage may be provided in the non-display area in which the dummy rib is formed. This ventilation passage may be prepared by forming no rib at a position to form the ventilation passage. The ventilation passage may have a linear-shape or a curved shape.

In the above structure, the ventilation passage may be formed by a plurality of ventilation passages, and the non-display area having the dummy rib formed therein may be divided into a plurality of island states by a plurality of these ventilation passages. In this case, an edge portion of a dummy rib, located at a corner of each area divided into the island state, is desirably formed with a round shape.

The ventilation passage is provided at a border portion between the display area and the non-display area, and an edge portion of a rib located at a corner of the display area may be formed with a round shape. Moreover, a rib to be positioned at an outer edge of the display area is desirably designed to have at least a width of the corner portion which is made wider than the width of a rib which is not positioned at the outer edge.

The ventilation passage is desirably formed so as to avoid a temporarily securing area in which the paired substrates are sandwiched by the clips upon aligning the paired substrates to be made face to face with each other and bonding the peripheral portion to be sealed.

Moreover, the present invention relates to a method for manufacturing the plasma display panel which includes processes in which the cell-defining rib, made of the longitudinal rib and the lateral rib, is formed on the display area of one of the substrates, and, upon forming the dummy rib having the same shape as that of the cell-defining rib in the non-display area which covers from the outer edge of the display area over to the peripheral portion of the substrate, the ventilation passage is formed in the non-display area in which the dummy rib has been formed, and then, one of the substrates is made face to face with the other substrate with its peripheral portions being bonded to be sealed, and upon carrying out the sealing/bonding process, the impurity gas is discharged from a gap between the two substrates.

Referring to Figs., the present invention will be described in detail by means of embodiments, hereinafter. Here, the present invention is not intended to be limited by these, and various modifications may be made therein.

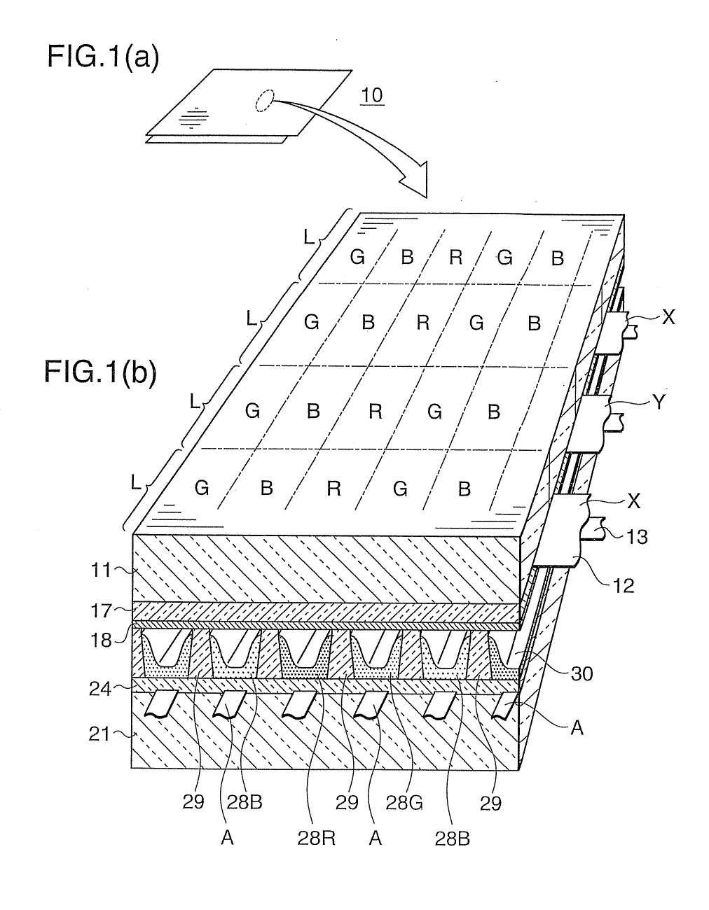

FIGS. 1(a) and 1(b) are explanatory drawings which show a structure of the PDP of the present invention. FIG. 1(a) is a general view, and FIG. 1(b) is a partially exploded perspective view. This PDP is a three-electrode surface-discharge-type PDP of an AC-drive type for a color display.

A PDP 10 is configured by a front side substrate 11 on which constituent elements having functions as the PDP are formed, and a backside substrate 21. As the frontside substrate 11 and the backside substrate 21, for example, a glass substrate is used; however, in addition to the glass substrate, a quartz substrate, a ceramic substrate or the like may be used.

On an inner side face of the front substrate 11, display electrodes X and display electrodes Y are disposed with equal intervals in a horizontal direction. All gaps between the adjacent display electrodes X and display electrodes Y form display lines L. Each of the display electrodes X and Y is configured by a transparent electrode 12 having a wide width, made of ITO, SnO₂ or the like, and a bus electrode 13 having a narrow width, made of metal, for example, Ag, Au, Al, Cu, and Cr, as well as a laminated body (for example, Cr/Cu/Cr laminated structure) thereof or the like. Upon forming these display electrodes X and Y, the thick-film-forming technique such as the screen-printing process is used for Ag and Au, and the thin-film-forming technique, such as the vapor deposition method and the sputtering method, and an etching technique are used for the other materials so that a desired number of electrodes having a desired thickness, width and gap can be formed.

Here, in the present PDP, a PDP having a so-called ALIS structure in which the display electrodes X and the display electrodes Y are placed with equal intervals, with each gap between the adjacent display electrode X and display electrode Y being allowed to form the display line L, has been exemplified; however, the present invention may also be applied to a PDP having a structure in which paired display electrodes X and Y are placed separately with a distance (non-discharge gap) in which no discharge is generated.

On the display electrodes X and Y, a dielectric layer 17 is formed in a manner so as to cover the display electrodes X and Y. The dielectric layer 17 is formed by processes in which a glass paste, made from a glass flit, a binder resin and a solvent, is applied onto the frontside substrate 11 by using the screen-printing method and fired thereon. The dielectric layer 17 may be formed by forming a SiO₂ film using the plasma CVD method.

A protective film 18, used for protecting the dielectric layer 17 from damage due to collision of ions generated by discharge upon displaying, is formed on the dielectric layer 17. This protective film is made from MgO. The protective film may be formed by using the known thin-film forming process in the art, such as an electron beam vapor deposition method and the sputtering method.

On the inner side face of the backside substrate 21, a plurality of address electrodes A are formed in a direction intersecting with the display electrodes X and Y on a plan view, and a dielectric layer 24 is formed in a manner so as to cover the address electrodes A. The address electrodes A generate an address discharge used for selecting cells to emit light at intersections with the display electrodes Y, and each of them is formed into a three-layer structure of Cr/Cu/Cr. These address electrodes A may also be formed by using another material, such as Ag, Au, Al, Cu and Cr. In the same manner as in the display electrodes X and Y, upon forming these address electrodes A, the thick-film-forming technique such as the screen-printing process is used for Ag and Au, and the thin-film-forming technique, such as the vapor deposition method and the sputtering method, and the etching technique are used for the other materials so that a desired number of electrodes having desired thickness, width and gap can be formed. The dielectric layer 24 may be formed by using the same materials and the same methods as those for the dielectric layer 17.

Lattice-like ribs 29, used for separating the discharge space for each cell, are formed on the dielectric layer 24 between the adjacent address electrodes A. The lattice-like ribs 29 are also referred to as box ribs, mesh-like ribs, waffle ribs and the like. The ribs 29 may be formed by using a sand blasting method, a photo-etching method or the like. For example, in the sand blasting method, a glass paste, made from a glass frit, a binder resin, a solvent and the like, is applied onto the dielectric layer 24, and after the glass paste has been dried, cut particles are blasted onto a resulting glass paste layer, with a cutting mask having apertures of a rib pattern being placed thereon, so that the glass paste layer exposed to the mask apertures is cut, and a resulting substrate is then fired; thus, the lattice-like ribs 29 are formed. Moreover, in the photo-etching method, in place of cutting by using the cut particles, a photosensitive resin is used as the binder resin, and after exposing and developing processes by the use of a mask, the resulting substrate is fired so that the lattice-like ribs 29 are formed.

On ide faces and a bottom face of a cell having a rectangular shape on the plan view, surrounded by the lattice-like ribs 29, phosphor layers 28R, 28G and 28B corresponding to red (R), green (G) and blue (B) are formed. The phosphor layers 28R, 28G and 28B are formed through processes in which a phosphor paste containing a phosphor powder, a binder resin and a solvent is applied onto inside of a cell surrounded by the ribs 29 by using the screen-printing method or a method using a dispenser, and after these processes have been repeated for each of the colors, a firing process is carried out thereon. These phosphor layers 28R, 28G and 28B may also be formed by using a photolithographic technique in which a sheet-shaped phosphor layer material (so-called green sheet) containing the phosphor powder, the photosensitive material and the binder resin is used. In this case, a sheet having a desired color may be affixed onto an entire face of a display area on the substrate, and the sheet is subjected to exposing and developing processes; thus, by repeating these processes for each of the colors, the phosphor layers having the respective colors are formed in the corresponding cell.

The PDP is manufactured through processes in which the frontside substrate 11 and the backside substrate 21 are aligned face to face with each other in a manner so as to allow the display electrodes X, Y and the address electrodes A to intersect with each other, and a peripheral portion thereof is sealed, with a discharge space 30 surrounded by the ribs 29 being filled with a discharge gas formed by mixing Xe and Ne. In this PDP, the discharge space 30 at each of intersections between the display electrodes X, Y and the address electrodes A forms one cell (unit light-emitting area) which is a minimum unit of a display. One pixel is configured by three cells of R, B and G.

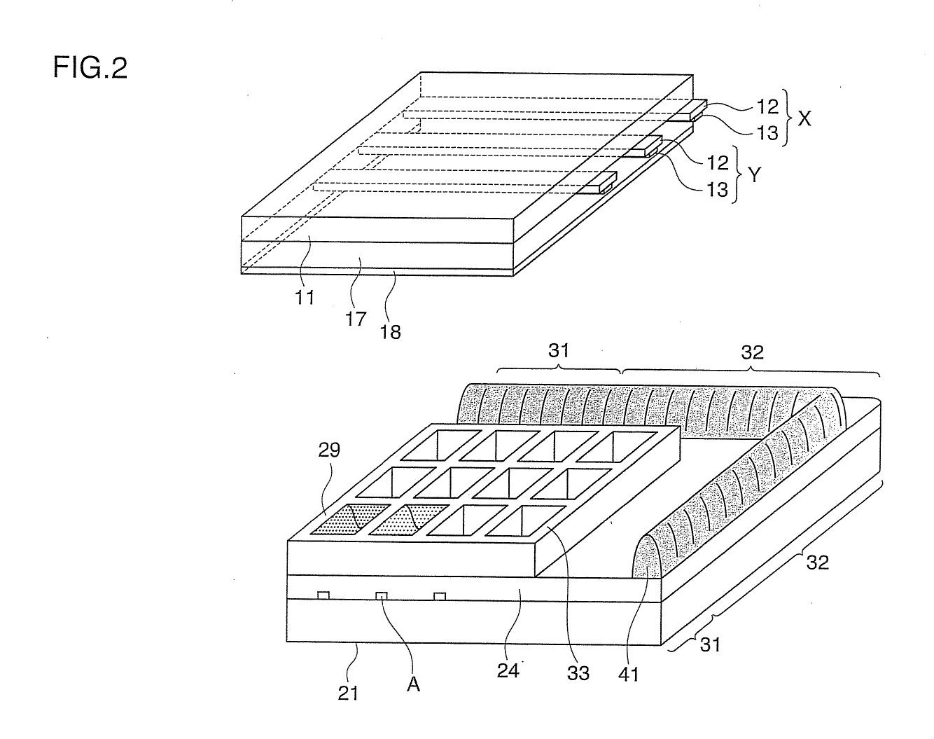

FIGS. 2(a) and 2(b) are partially exploded perspective views which show the PDP in detail. FIG. 2(a) shows the frontside substrate, and FIG. 2(b) shows the backside substrate.

As shown in FIG. 2(b), on the backside substrate 21, a cell-defining rib 29 made of the longitudinal ribs and the lateral ribs is formed on a display area 31, and continuously from the cell-defining rib on the display area, a dummy rib 33 having the same shape as that of the cell-defining rib is formed on a non-display area 32 which is placed so as to cover from an outer edge of the display area 31 over to a peripheral portion of the substrate.

The cell-defining lattice-like rib formed on the display area 31 is referred to as a box rib 29, and a lattice-like rib formed on the non-display area 32 is referred to as the dummy rib 33.

The phosphor layers are formed in each of cells on the display area 31, while no phosphor layers are formed in each of cells on the non-display area 32. The ventilation passage, which will be described later, is formed in the non-display area 32 on which the dummy rib 33 is formed.

A glass sealing material 41 is applied onto the periphery of the backside substrate 21. This glass sealing material 41 is obtained through processes in which the glass paste, made from the glass frit, the binder resin, and the solvent, is applied thereto, and dried thereon, and this is then temporally fired so that the binder resin component is burned to disappear.

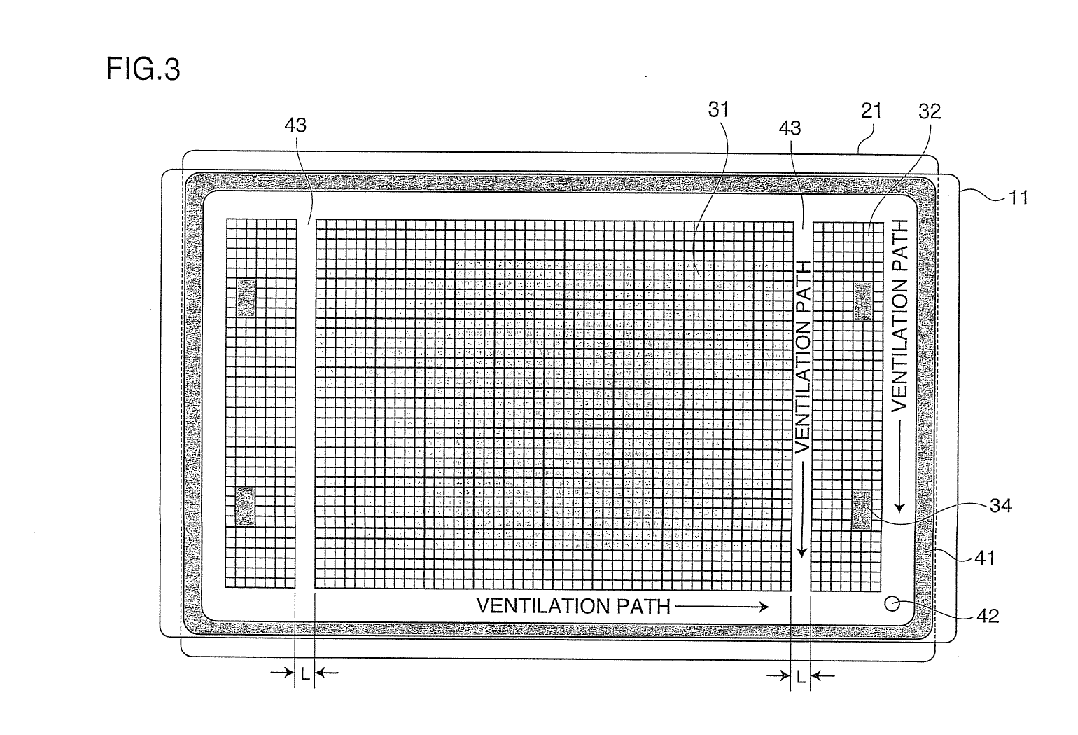

FIG. 3 is an explanatory drawing which shows a structural state on the plan view of the PDP of embodiment 1.

As described earlier, the PDP 10 is manufactured through processes in which the frontside substrate 11 on which the display electrodes, the dielectric layer and the protective film are formed and the backside substrate 21 on which the address electrodes, the dielectric layer, the lattice-like rib and the phosphor layers are formed are aligned face to face with each other, and the peripheral portion of the substrates is sealed with the glass sealing material 41, with the discharge space surrounded by the ribs being filled with the discharge gas formed by mixing Xe and Ne. The box rib is formed on the display area 31 of the backside substrate 21, and the dummy rib is formed on the non-display area 32.

Here, on the non-display area 32 where the dummy rib has been formed, linear ventilation passage 43, each having a width of L, are formed on right and left sides of the substrate in the longitudinal direction. This ventilation passage 43 is formed described below.

The box rib and the dummy rib are formed by using the sand blasting method. In this sand blasting method, the glass paste, made from the glass frit, the binder resin, the solvent and the like, is applied onto the substrate, and after the glass paste has been dried thereon, cut particles are blasted onto the resulting glass paste layer, with the cutting mask having apertures of the rib pattern being placed thereon, so that the glass paste layer exposed to the mask apertures is cut, and the resulting substrate is then fired; thus, the box rib and the dummy rib are formed. In this case, the cutting mask is formed by processes in which, after a photosensitive dry film resist has been laminated on the substrate, this is exposed through a photo-mask, and then developed, and the ventilation passage 43 may be formed by preparing the shape of the photo-mask at this time as a shape with ventilation passage. When the ribs are formed by using the photo-etching method, the ventilation passage is also formed by preparing the shape of the photo-mask as a shape with ventilation passage.

In the sealing/bonding process for sealing/bonding the peripheral portions of the frontside substrate 11 and the backside substrate 21, after the glass sealing material 41 has been applied to the periphery of the backside substrate 21, and then temporarily fired thereon, the frontside substrate 11 is made to face the backside substrate 21, and the two substrates are sandwiched by the clips (not shown) made of metal, and temporarily secured to each other, and in this state, a heating process is carried out thereon so that the two substrates are air-tightly bonded to each other. In this heating process, while the glass sealing material 41 is being heated to be fused, air is drawn through a ventilation hole 42 formed in the backside substrate 21 to apply a negative pressure to the inside of the PDP so that the impurity gas is exhausted from the inside of the PDP, and the discharge space inside the PDP is successively filled with the discharge gas. At this time, a gap between the non-display area 32 and the glass sealing material 41 and the ventilation passages 43 serve as ventilation (exhaust) paths.

The above temporarily securing process by the clips is carried out by sandwiching clip-sandwiching areas (temporarily securing areas) 34 formed on four portions of the periphery of the substrates with clips. Therefore, the dummy ribs are formed up to the clip-sandwiching areas 34 so that the frontside substrate 11 and the backside substrate 21 are not curved by the sandwiching clips, and sealed and bonded to each other with a predetermined gap.

In the present embodiment, the clip-sandwiching areas 34 are prepared at four portions on the right and left sides of the panels; however, positions, number and size of the clip-sandwiching areas 34 are not particularly limited. However, in order to maintain balance relative to a panel strength, clip positions are desirably disposed with equal intervals.

In the present embodiment, the box ribs and the dummy ribs are separated from each other on each short side of the substrate, and this separated portion is formed into the ventilation passage 43 having a width L so as to be utilized as the ventilation path. Therefore, the dummy ribs are separated by the ventilation passage 43 into an island state. As described above, the dummy rib with its periphery completely separated from other ribs is referred to as an island-state dummy rib.

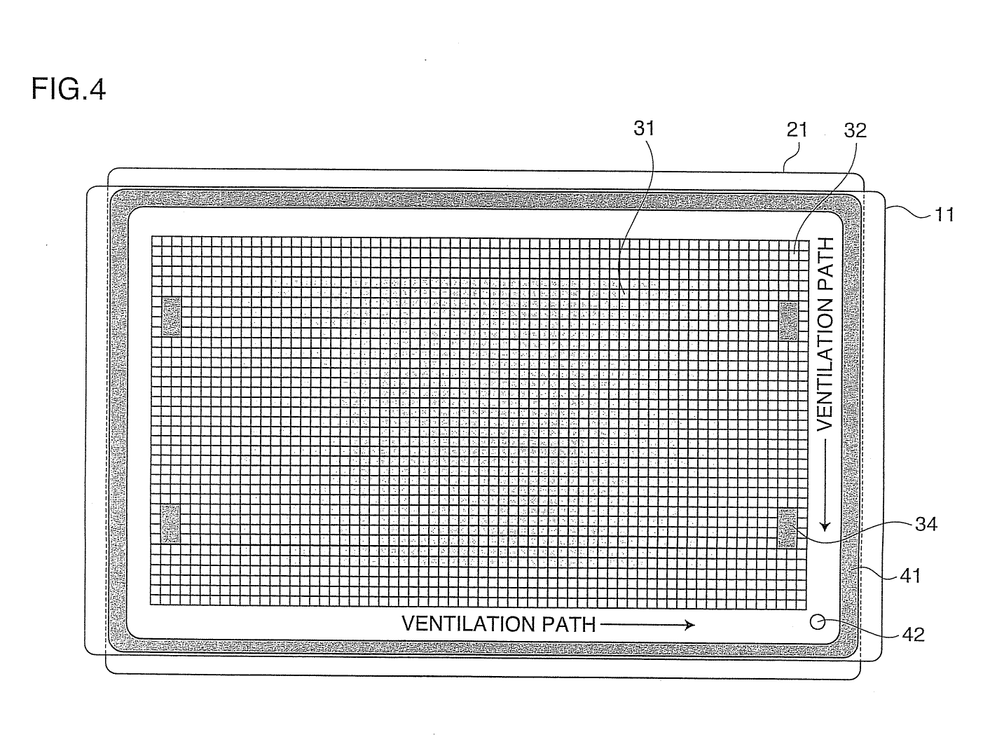

FIG. 4, which shows a comparative example, is an explanatory drawing which shows a state on the plan view of a PDP having no ventilation passage formed therein. As shown in this Fig., when no ventilation passage is formed in the non-display area 32, the ventilation path to be used in the sealing/bonding process is only given by the gap between the non-display area 32 and the glass sealing material 41.

In contrast, in the above embodiment, since the ventilation passage is formed, the exhausting operation of the impurity gas and a filling operation of the discharge gas can be sufficiently carried out. Moreover, the dummy rubs at the clip positions are virtually the same as those of the comparative example, the panel strength which is virtually the same as strength of the comparative example can be obtained.

In this manner, the ventilation passage which penetrates the non-display area is formed within the non-display area in which the dummy ribs are formed, with a temporarily securing area for the clips being maintained, and this ventilation passage is maintained as the ventilation path. With this arrangement, while the substrates are sandwiched by the clips in the same manner as in a conventional structure, the exhausting operation of the impurity gas and the filling operation of the discharge gas in the sealing/bonding process can be preferably carried out so that it becomes possible to improve a quality of the PDP.

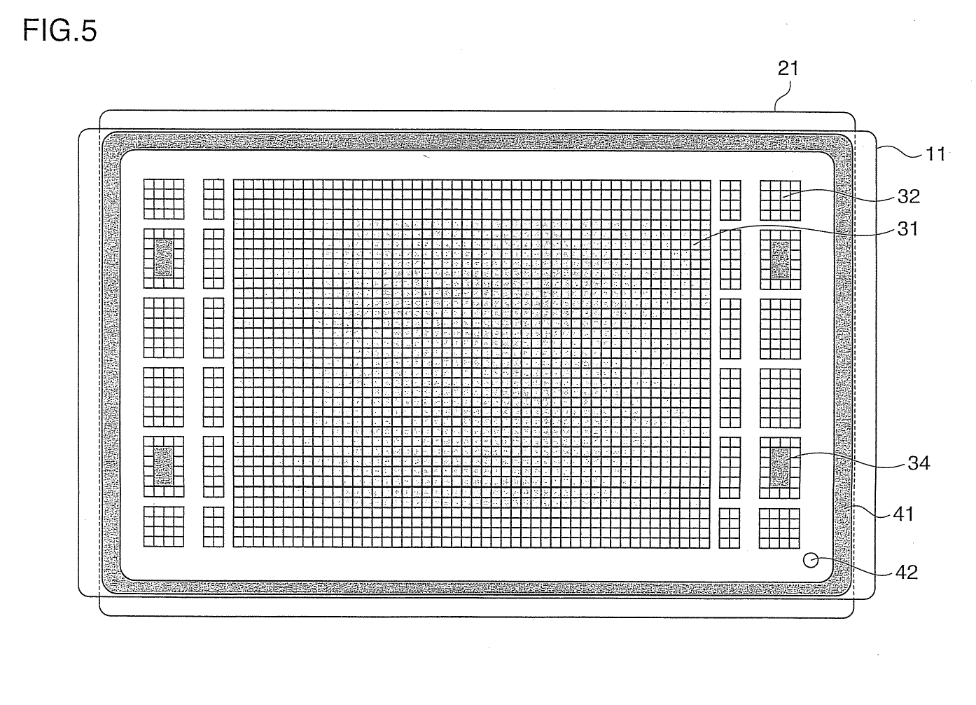

FIG. 5 is an explanatory drawing which shows a structural state on the plan view of a PDP of embodiment 2.

This embodiment differs from embodiment 1 in which right and left island-state dummy ribs are divided into a plurality of island-state dummy ribs. With this arrangement, a plurality of ventilation passages are formed among the dummy ribs, and a plurality of these ventilation passages can be utilized as ventilation paths. When the width of each ventilation path is made too wide, the panel strength against an external pressure is lowered; however, by using a plurality of the island-state dummy ribs thus separated in the present embodiment, the ventilation path can be widened without a reduction in the panel strength against the external pressure.

Also in this case, the ventilation passage is not placed within the clip-sandwiching area. However, so as not to cause deviations in a ventilation conductance inside the panel, the island-state dummy ribs are preferably placed with equal intervals based upon the clip-sandwiching area.

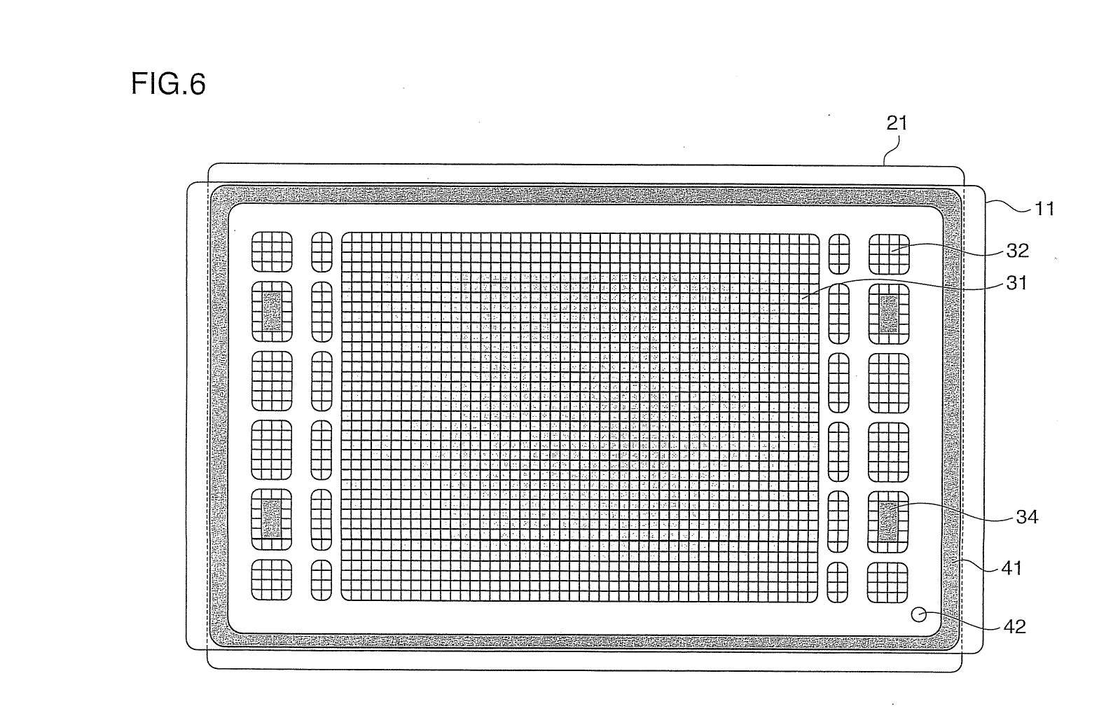

FIG. 6 is an explanatory drawing which shows a structural state on the plan view of a PDP of embodiment 3.

This embodiment differs from embodiment 2 in which an R-shape is provided on each of the corner portions of the dummy rib positioned on each of the corners of island-state dummy ribs divided into a plurality of portions, so as to form a round shape.

The reason for this structure is described as follows: that is, upon forming the box ribs and the dummy ribs, when these are formed by using sand blasting, a side cut tends to occur in the rib at the end portion of the rib in a nozzle shifting direction of the cutting mask, upon shifting a nozzle used for blasting cutting particles.

Consequently, upon firing the ribs in a succeeding firing process, this side-cut portion tends to protrude upward. When the rib end portion protrudes upward, upon aligning the backside substrate and the frontside substrate face to face with each other, the frontside substrate is warped due to this protruding portion, and this warped frontside substrate vibrates due to influences of driving pulses upon application of a voltage to the electrodes, with a result that these vibrations enter an audible region to occasionally cause an abnormal noise.

Therefore, in order to prevent this upward protrusion, the R-shape is formed on each of the corner portions of the dummy rib positioned on the corner of each island-state dummy rib so that the corner portion is formed into the round shape. In this case, by taking this upward protrusion into consideration, the height of the dummy ribs may be preliminarily designed to be slightly lower, upon forming the ribs.

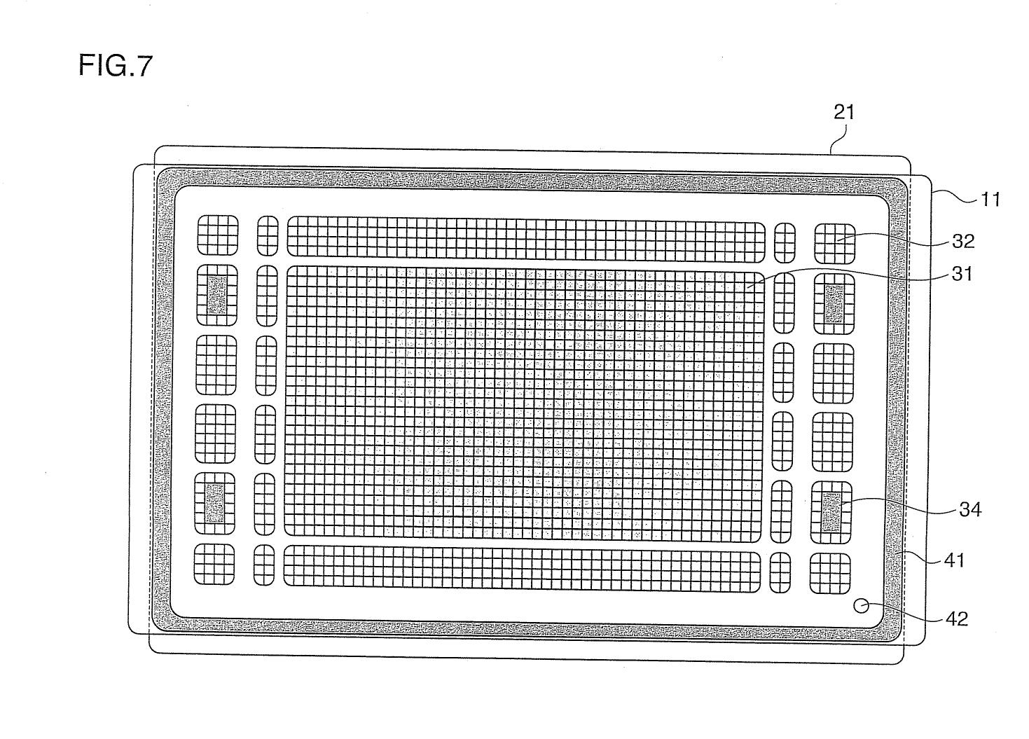

FIG. 7 is an explanatory drawing which shows a structural state on the plan view of a PDP of embodiment 4.

This embodiment differs from embodiment 3 in which ventilation passages are formed on four sides of the periphery of the display area. That is, the ventilation passages are provided on all the border portions between the display area and the non-display area, and an R-shape is formed on each of the corner portions of the box rib positioned on each of the corners of the display area so as to form a round shape.

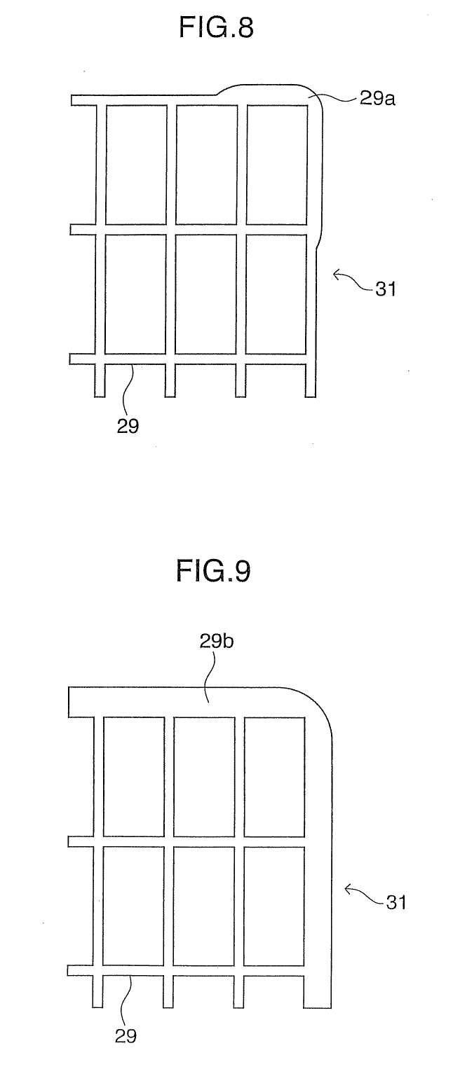

The reason for this shape, which is the same as the above reason, is to prevent the end portion of the rib from protruding upward. However, when ventilation passages are formed on the four sides of the display area, the box ribs on the display area might collapse to impair the display cells on the end portions of the display area. FIGS. 8 and 9 show solutions to this problem.

FIGS. 8 and 9 are plan views which shows box ribs located on the corners of the display area in the PDP of the present invention. FIG. 8 shows an example in which a width of a corner rib is made wider, and FIG. 9 shows an example in which a width of a peripheral rib is made wider.

In a first solution, as shown in FIG. 8, the width of the corner portion 29a of the box rib located on each of the corners of the display area is made wider than the width of the other box ribs 29. With this structure, the corner portion 29a of the box rib is formed into the R-shape without impairing the display cells. In order to further reduce an amount of upward protrusion, the greater the radius of R, the better. However, in order to prevent deviations in the amount of upward protrusion from becoming larger, an attempt is made so as not to make the rib too wide.

In a second solution, as shown in FIG. 9, the width of the outer edge box ribs 29b located on the outer edge of the display area is made wider than the width of the box ribs 29 which are not positioned on the outer edge. When the width of the outer-edge box ribs 29b is made wider, the ventilation path is slightly narrowed; however, the R-shape of the corner portion can be made larger.

In this manner, by providing the ventilation path in the non-display area in which dummy ribs are formed, it is possible to ensure the ventilation path to be used upon carrying out the sealing/bonding process on the substrates so that the exhausting operation of the impurity gas and the filling operation of the discharge gas can be sufficiently carried out. Moreover, since the ventilation path between the dummy ribs and the glass sealing material is made narrower by providing the ventilation passage in the non-display area, and as a result, it becomes possible to make the outer shape of the panel smaller.

As described above, in accordance with the present embodiments, the exhausting operation of the inside of the panel and the filling operation of the discharge gas into the panel can be preferably carried out in the PDP having the closed-type rib structure by forming the ventilation passage in the non-display area with the temporarily securing area by clips being maintained, so that it becomes possible to improve the quality of the PDP.

1. A plasma display panel, which has a paired substrates facing each other, the peripheral portions of which are bonded to each other to be sealed, and is manufactured by allowing an impurity gas located between the substrates to be exhausted upon carrying out the sealing/bonding process, the plasma display panel comprising:
a cell-defining rib having longitudinal ribs and lateral ribs, which is formed in a display area between the paired substrates; and
a dummy rib having the same shape as that of the cell-defining rib, which is formed in a non-display area which covers from an outer edge of the display area over to the periphery of the substrates, a ventilation passage being formed in the non-display area in which the dummy rib is formed.

2. The plasma display panel according to claim 1, wherein the ventilation passage is made of a plurality of ventilation passages, and the non-display area in which the dummy rib is formed is divided into a plurality of island shapes by a plurality of these ventilation passages.

3. The plasma display panel according to claim 2, wherein each dummy rib located on each of corners of areas divided into the island shapes has a corner portion which is formed into a round shape.

4. The plasma display panel according to claim 2, wherein the ventilation passage is provided on a border portion between the display area and the non-display area, with each rib, located on each of corners of the display area, having a corner portion which is formed into a round shape.

5. The plasma display panel according to claim 4, wherein a rib located on the outer edge of the display area has a width of at least each corner portion which is wider than a width of a rib which is not located on the outer edge.

6. The plasma display panel according to any one of claims 1 to 5, wherein the ventilation passage is formed in a manner so as to avoid a temporarily securing area in which, when the paired substrates are aligned face to face with each other and the peripheral portions are bonded and sealed with each other, the paired substrates are sandwiched by a clip.

7. A method for manufacturing a plasma display panel comprising the steps of:
forming a ventilation passage on a non-display area in which a dummy rib has been formed upon forming a cell-defining rib having longitudinal ribs and lateral ribs on a display area of one of substrates, as well as forming the dummy rib having the same shape as that of the cell-defining rib on the non-display area which covers from an outer edge of the display area over to a peripheral portion of the substrate; then
allowing one of substrates to be made face to face with other substrate and carrying out a sealing/bonding process on peripheral portions thereof; and
exhausting an impurity gas from a gap between the two substrates upon carrying out the sealing/bonding process.
